(19) United States
(12) Patent Application Publication
(10) Pub. No.: US 2023/0014089 A1
(43) Pub. Date: Jan. 19, 2023

(54) RAIN GAUGE DEVICE

(71) Applicant: Sencrop, Lille (FR)

(72) Inventor: Bruno Boissenin, Faches Thumesnil (FR)

(21) Appl. No.: 17/753,516

(22) PCT Filed: Sep. 4, 2020
(86) PCT No.: PCT/EP2020/074868

§ 371 Date: Sep. 7, 2022

(30) Foreign Application Priority Data
Sep. 5, 2019 (FR) FR1909765

(51) Int. Cl. G01W 1/14; G01G 19/00

(52) U.S. Cl. CPC G01W 1/14; G01G 19/00

(57) ABSTRACT

A rain gauge device comprises a water collector configured to receive water, the rain gauge device being movable between a water collection position and an emptying position, a measuring means 106 configured to measure a parameter representative of a weight measurement, and a control unit configured to use the measuring means to perform a plurality of weight measurements.

### CROSS-REFERENCE TO RELATED APPLICATIONS

This application is a national phase entry under 35 U.S.C. § 371 of International Patent Application PCT/EP2020/074868, filed Sep. 4, 2020, designating the United States of America and published as International Patent Publication WO 2021/044033 A1 on Mar. 11, 2021, which claims the benefit under Article 8 of the Patent Cooperation Treaty to French Patent Application Serial No. FR1909765, filed Sep. 5, 2019.

### TECHNICAL FIELD

The present disclosure relates to the field of rainfall and to an automatic draining rain gauge device, in particular, to an automatic draining rain gauge device measuring the weight of rain.

### BACKGROUND

Such devices are known in the art, for example, by International Patent Application Publications WO2015/148320 or WO2017/160239. In the field of meteorology, it is known to use rain gauge devices to determine the amounts of water received on the ground per unit area. A rain gauge is equipped with a container for collecting rainfall. Different types of rain gauges exist.

For example, volume-counting rain gauges are used. The method of this automatic rain gauge consists of guiding the precipitation into small containers that empty automatically when they are full and counting the number of times they empty. Since their volume is known, it is possible to automatically totalize the volume of water that has fallen. These automatic rain gauges are tipping bucket rain gauges. These rain gauges encounter several problems related to the clogging of the buckets, which results in a poor repeatability of the tilting due to friction, to the give in the rotation, or to a poor emptying of the buckets, which results in an imbalance of the device and a falsified measurement.

To limit these inconveniences, automatic weighing rain gauges are used nowadays. This type of rain gauge collects the rain in a small container placed on a strain gauge whose role is to weigh the container and the vessel.

The reliability of the strain gauge is a crucial point for this type of rain gauge and this component is often not stable over time. Moreover, these types of devices are very sensitive to external disturbances, such as wind vibrations, or the passage of birds or tractors on the ground, which disturb the measurement of rain weight. Moreover, they are also sensitive to temperature variations.

In the case of the rain gauge described in International Patent Application Publication WO2015/148320, the rain gauge includes an armature magnetically coupled to a magnet providing resistance to the weight of the collected fluid. The weight of the collected fluid, once sufficient or exceeding a threshold, can provide a force opposite to the magnetic attraction force and cause the collection vessel to pivot from a collection and measurement position to a fluid discharge position. In addition, the use of a magnet allows the collection vessel to return well to its original position when discharged and not remain in an intermediate position between the discharge position and the collection position, as may be the case when the collection vessel tilts due to the weight of the collected fluid alone. However, the use of a magnet on the collection vessel can interfere with the measurement of the force sensor. Furthermore, when the magnet used is an electromagnet, as, for example, in Japanese Patent Application Publication JP S61 79184 A, then the device requires a significant higher power consumption compared to using a counterweight or magnet at the collection vessel.

The devices of the state of the art that allow to have a temporal information on the rain, that is to say, for example, to know the beginning of the rain, or to have more information on the type of rain, such as a heavy rain with big drops or a fine rain, are systems constantly switched on which requires a continuous power supply limiting strongly their autonomy in energy, even their place of installation.

Finally, the state of the art rain gauges are generally used in the field of meteorology, for which they require a daily or weekly follow-up for their maintenance. Moreover, these devices are not adapted to the agricultural field where the use of agricultural machines in the field can disturb the measurements.

Thus, it is an object of the present disclosure to improve the reliability of the determination of rain measurement by an automatic discharge rain gauge device that allows for accurate and more efficient rain measurement by providing more rain information, as compared to the prior art device, for suitable use in the agricultural field.

It is therefore an object of the present disclosure to overcome the disadvantages described above by providing a rain gauge device comprising a water collector configured to receive water, being movable between a water collection position and an emptying position, a measuring means configured to measure a parameter representative of a weight measurement, wherein the device may further comprise a control unit configured to use the measuring means to perform a plurality of weight measurements. Further, the measuring means may be a forcesensor configured to perform a plurality of weight measurements.

Thus, the device of the present disclosure allows a weight change to be measured throughout the rainfall measurement. The device performs a plurality of weight measurements at several given times, i.e., not only at the time of tipping. Moreover, the plurality of measurements allows to have a representative sample of the weight taking into account several external factors (vibrations, winds) and an average value of the weight measurement can be obtained.

### BRIEF SUMMARY

According to one embodiment of the present disclosure, the force sensor may be a support element connected at one end to the water collector and at its other end to a support, in particular, the support element is a beam. Thus, when the support member flexes under the weight of the water collector, a weight measurement is made corresponding to the flexing of the support member.

According to one embodiment of the present disclosure, the force sensor may be configured to be mechanically isolated from the enclosure, in particular, by way of the support. Thus, the force sensor is not mechanically coupled directly to the envelope of the device. This mechanical decoupling between the measuring means and the envelope reduces the transmission of vibration from the envelope to the measuring means, and thus reduces the influence of external parameters such as vibrations due to wind or ground vibrations on the measuring means and thus improves the quality of measurements made by the measuring means.

According to one embodiment of the present disclosure, the measuring means may comprise a Wheatstone bridge, the measuring means being configurable to measure a plurality of electrical resistance measurements.

The Wheatstone bridge is a known state of the art system having four resistors connected together, three of which are known and fixed and one is unknown and variable. The Wheatstone bridge allows the variation of the unknown resistance to be measured and associated with a measured parameter. Thus, when the support element flexes under the weight of the water collector, the unknown resistance varies proportionally with the weight, which makes it possible to measure the weight of the collector. In the device according to the present disclosure, the Wheatstone bridge is used to also reduce the impact of temperature differences on the measurement. In addition to the variation of the unknown resistance, the other three resistances are also continuously measured. All resistors change in the same way with temperature variation. Thus, by taking into account the plurality of electrical resistance measurements, instead of relying on the value of the resistances communicated at 25 C°, the temperature variation is automatically compensated electrically. Thus, the device according to the present disclosure allows to reduce the sensitivity of the rainfall measurements to the temperature variations, contrary to the device of the state of the art that have a high sensitivity to the temperatures.

According to an embodiment of the present disclosure, the control unit may be configured to reset the measuring means after a tilt of the water collector.

Thus, the device of the present disclosure avoids measurement drift due to water evaporation because the weight measurement is reset to zero at the beginning of each rainfall. The measurements made by the device according to the present disclosure are more reliable and accurate than in the devices of the state of the art.

According to an embodiment of the present disclosure, the control unit can be configured to reset the measuring means after a tilting of the water collector, taking into account the tare of the water collector. Thus, the measurements made by the device according to the present disclosure are more reliable and correct than in the devices of the state of the art, because measurement drifts due to water evaporation are avoided by resetting the weight measurement at the beginning of each rainfall.

According to one embodiment of the present disclosure, the rain gauge device as described above may further comprise a tilt detection means, in particular, a switch, in particular, a reed switch. In this way, the tilt detection is done accurately and precisely and allows the measuring means to be reset to obtain an accurate measurement.

According to one embodiment of the present disclosure, the control unit can be configured to trigger a measurement of the measuring means at the time of tilting of the water collector and when the water collector has returned to its water collection position. In this way, the device makes it possible to obtain a measurement at the time of tilting and thus to obtain an accurate measurement of the rainfall, as well as to repeat the measurements accurately, at a given time and with a given weight.

According to one embodiment, the device may be configured such that the control unit may be put into sleep mode and may further comprise a trigger means configured to wake up the control unit. Thus, the device of the present disclosure allows the control unit to be interrogated when necessary, and does not require continuous power consumption, thereby reducing the power consumption of the rain gauge device.

According to an embodiment, the triggering means may be configured to wake up the control unit upon exceeding a threshold of the parameter representative of a weight measurement of the measuring means. According to one embodiment, the triggering means may be configured to wake up the control unit upon a downward overshoot of a low threshold or to wake up the control unit upon an upward overshoot of a high threshold. Thus, the measurements made by the device are more reliable and accurate than in the devices of the state of the art, because they take into account the phenomenon of evaporation and make it possible to separate the evaporation from the rain measurement when a weight measurement is made.

According to one embodiment, the device may comprise a temperature measuring means and/or a humidity measuring means and wherein the control unit may be configured to take into account the temperature and/or the humidity level when determining the weight. Thus, the rain gauge device can obtain data on parameters external to the device, such as air temperature, humidity level and allows for a more reliable measurement of rainfall, compared to the device of the state of the art.

According to one embodiment, the control unit may be configured to detect the presence or absence of dew based on temperature and/or humidity. Thus, the rain gauge device can obtain data on parameters external to the device, such as air temperature and humidity level. These ambient parameters allow the dew phenomenon to be determined, which can have an influence on the rain measurement performed. Thus, being able to determine the dew from these ambient parameters makes it possible to obtain a “real” rain measurement without the dew, and thus a more reliable measurement of the rain, compared to the device of the state of the art.

According to one embodiment, the rain gauge device may comprise a casing, such that the water collector and the measuring system are positioned inside the casing, wherein the casing comprises a central portion comprising a side wall at least partially curved laterally toward the interior of the casing, in particular, in combination with a flared upper portion and/or a flared lower portion.

The curved shape of the central portion of the envelope, in particular, in combination with the upper and lower flared portions of the envelope, allow the envelope to have an aerodynamic shape and to reduce the wind load of the rain gauge device, in contrast to a straight vertical cylindrical shape of the envelopes of the state of the art. Thus, the rain gauge device of the present disclosure makes it possible to make rainfall measurements by reducing the disturbance on the raindrops and the vibrations on the structure related to the wind in the measurement, thus a better reliability of the measurements is obtained with this device, compared to the devices of the state of the art.

According to one embodiment, the rain gauge device may further comprise a second measuring means, the second measuring means being a water collector vibration measuring means being located at the water collector.

Thus, the device of the present disclosure provides more information about the rainfall, for example, the type of rain, light or heavy rain, dense, as well as, for example, temporal information, such as the duration of the rain and the start of the rain. This thus allows the device of the present disclosure to obtain more accurate rainfall measurements compared to devices of the state of the art, because the measurement made by the device of the present disclosure includes more information than a device of the state of the art.

According to a variant, the rain gauge device can include a third measuring means, the third measuring means being a vibration measuring means located at the envelope and/or at a support. The third means of vibration being located at the level of the envelope or of an external support makes it possible to obtain information on external disturbances, such as vibrations due to the wind or vibrations of the ground and thus make it possible to take them into account for a better evaluation of the measurements of rainfall made by the device. In particular, the measuring means can be an accelerometer to measure the impact of the wind. This means of vibration makes it possible to learn information of vibrations related to phenomena other than the rain, to eliminate the noise of measurement thus to refine the measurement of the rain.

According to one embodiment of the present disclosure, the vibration measuring means of the second and/or third means may be an accelerometer or a piezoelectric sensor. A piezoelectric sensor provides a voltage proportional to the shocks it receives. Thus, with the piezoelectric sensor, the additional vibration measurement on the water collector provides accurate and reliable information about the type of rain and the duration and onset of the rain, information that is not obtained in the rain gauge device of the state of the art, and that influences the measurement.

According to a variant, the device can comprise an autonomous energy supply device, in particular, electrical, solar, wind or thermal energy. The device comprising a reduced energy consumption, it is possible to use it without connection to an electrical network. The autonomous energy supply device, e.g., a battery, a photovoltaic sensor, makes it possible to obtain an essentially energy autonomous measuring device. This allows the installation of the measuring device at several locations in a field, for example, in the agricultural field, without the need to install power lines.

### BRIEF DESCRIPTION OF THE DRAWINGS

The present disclosure may be understood by reference to the following description taken in conjunction with the accompanying figures, in which numerical references identify the elements of the present disclosure.

FIG. 1A represents a side view of the rain gauge device according to a first embodiment of the present disclosure.

FIG. 1B shows a side view of the rain gauge device according to a variant of the first embodiment of the present disclosure.

FIG. 1C represents a side view of the rain gauge device according to another variant of the first embodiment of the present disclosure.

FIG. 2 represents a front view of the rain gauge device according to the first embodiment of the present disclosure.

FIG. 3A represents a three-dimensional (3D) view of the rain gauge device according to the first embodiment of the present disclosure.

FIG. 3B represents a 3D top view of the rain gauge device according to the first embodiment of the present disclosure.

FIG. 3C represents a 3D view from below of the rain gauge device according to the first embodiment of the present disclosure.

FIG. 4 represents a side view of the rain gauge device according to a second embodiment of the present disclosure.

FIG. 5A represents a side view of the rain gauge device according to a third embodiment of the present disclosure.

FIG. 5B represents a schematic of the measuring means according to the third embodiment of the present disclosure shown in FIG. 5A.

FIG. 6 represents a side view of the rain gauge device according to a fourth embodiment of the present disclosure.

FIG. 7 represents a side view of the rain gauge device according to a fifth embodiment of the present disclosure.

FIG. 8A shows a side view of the rain gauge device according to a sixth embodiment of the present disclosure.

FIG. 8B shows a side view of the rain gauge device according to a seventh embodiment of the present disclosure.

### DETAILED DESCRIPTION

The present disclosure will now be described in more detail using advantageous embodiments in an exemplary manner and with reference to the drawings. The embodiments described are merely possible configurations, and it should be kept in mind that individual features as described above may be provided independently of each other or may be omitted altogether when implementing the present disclosure.

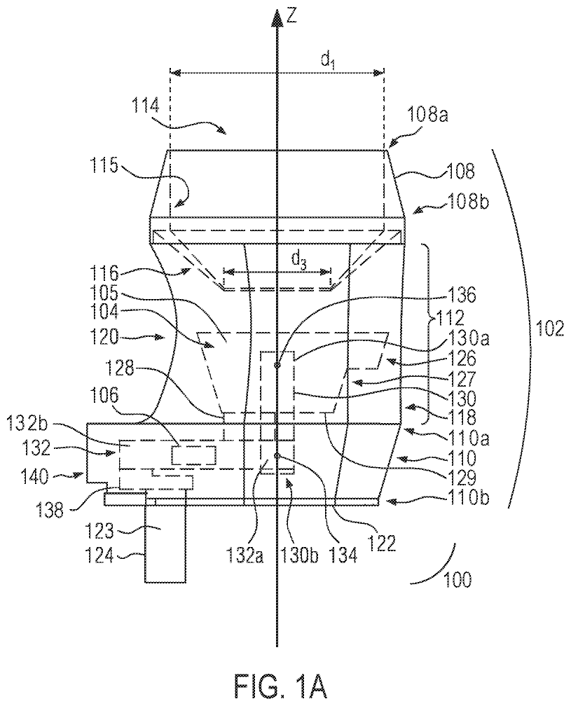

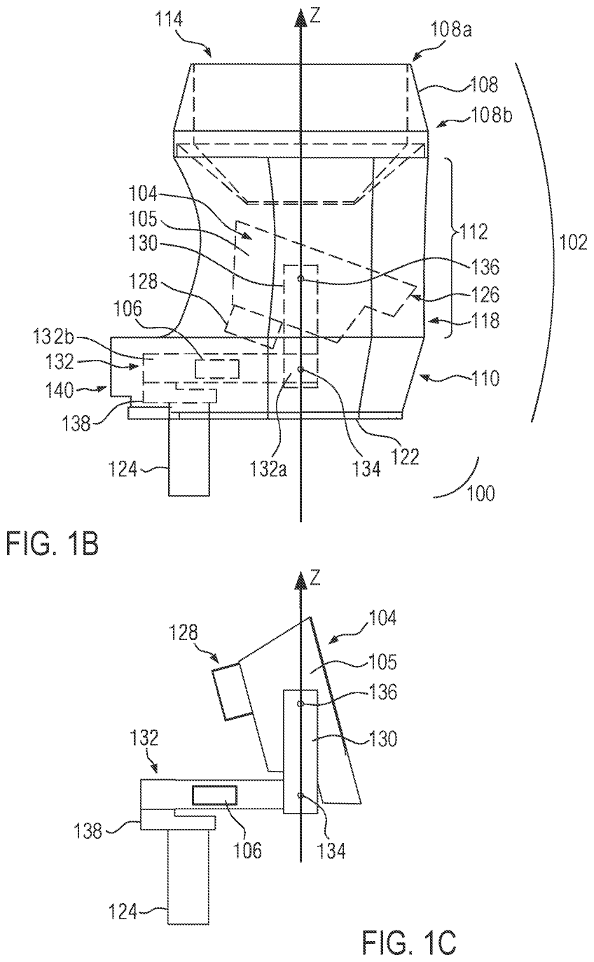

FIG. 1A shows a rain gauge device 100 according to a first embodiment of the present disclosure.

The rain gauge device 100 comprises a casing 102, a water collector 104, itself comprising a container 105, and a measuring means 106.

The envelope 102 is an outer envelope such that the water collector 104 and measuring means 106 are positioned within the envelope 102. In FIG. 1A, the outer shell 102 is made of a single piece, but in one embodiment it may be assembled of multiple pieces.

The envelope 102 has an elongated shape in the vertical direction Z with an upper portion 108, a lower portion 110, and a central portion 112. The upper portion 108 is located on the upper part of the envelope 102 facing the sky and the lower portion 110 is located on the lower part of the envelope 102 facing the ground when the rain gauge device 100 is in use. The central portion 112 of the envelope 102 is recessed and includes a sidewall 118.

The casing 102 includes an opening 114, preferably circular with a diameter di, in its upper 108 portion, on a face 108a of the upper portion 108 through which water enters the rain gauge device 100. The diameter di of the opening 114 determines the water collection area. The diameter di is defined by the World Meteorological Organization (WMO) and ensures a reliable measurement of rainfall by the device. The diameter di of the opening 114 is between 200 cm² and 500 cm², which corresponds to the standard, in particular, between 200 cm² and 300 cm². The standard is defined in the “Guide to Meteorological Instruments and Methods of Observation” WMO-N°8, 2017 update.

The upper portion 108 includes in its interior an internal vertical wall 115 terminating in a funnel shape 116, being located at the upper level of the central portion 112 of the envelope 102. The funnel shape 116 is centrally positioned within the envelope 102, along the central axis Z, so that water entering through the opening 114 of the upper portion 108 of the envelope 102 is collected by the funnel shape 116.

The funnel shape 116 of the inner portion of the envelope 102 includes a steep slope with an angle α greater than 45° to limit the splashing of water out of the envelope 102, for example, if rainfall is heavy. In addition, due to the vertical wall 115 extending from the funnel shape 116, the inner portion of the envelope 102 is protected from wind and detritus.

The upper portion 108 of the envelope 102 is flared between its end face 108a and a part 108b toward the central portion 112 of the envelope 102. The flaring of the upper portion 108 of the envelope 102 provides improved aerodynamics of the envelope 102 and thus the device 100.

The funnel shape 116 within the envelope 102 has a diameter d3 being less than the diameter di of the opening 114 of the upper portion 108 of the envelope 102.

In one embodiment, the upper portion 108 further comprises a filtering means. This filtering means removes impurities present in the rain or in the inlet of the upper portion.

The wall 118 of the central portion 112 of the envelope 102 is at least partially curved over a portion 120 of the wall 118. The curved portion 120 of the wall 118 is curved horizontally toward the interior of the envelope 102. In FIG. 1A, the curved portion 120 is visible on the left side of the wall 118 of the central portion 112 of the envelope 102, while the right side of the wall 118 is shown as a straight portion.

The curved shape of a portion 120 of the central portion 112 of the envelope 102 in combination with the upper 108 and lower 110 flared portions of the envelope 102 allow the envelope 102 to have a more aerodynamic shape and reduce the windage of the rain gauge device 100, as opposed to a straight vertical cylindrical shape of the envelopes of the state of the art rain gauge devices.

The lower portion 110 of the envelope 102 also has a flared or beveled external shape, such that the face 110a of the lower portion 110 on the central portion 112 side is wider than the face 110b of the lower portion 110 on the ground side when using the rain gauge device 100. The envelope 102 further includes a bottom surface 122, here in the form of a cover, positioned at the bottom face 110b to close the lower portion 110 of the envelope 102. Thus, the water collector 104 and the measuring means 106 are protected from negative influences of external parameters such as wind or flying detritus since they are enclosed in the envelope 102 and the bottom surface 122. The flaring of the lower portion 110 of the envelope 102 ensures better aerodynamics of the envelope 102 and thus the device 100.

The envelope 102 has a recess 140 at the lower flared portion 110 of the envelope 102. This recess 140 allows the passage of cables necessary for the electrical connections inside the device 100.

In FIG. 1A, the rain gauge device 100 further comprises a support 124. The support 124 includes a portion 123 that extends from the bottom surface 122 of the rain gauge device 100 outwardly, preferably vertically along the Z direction. The bracket 124 is configured such that it allows the rain gauge device 100 to be planted in the ground and thus allows for a secure and solid attachment of the rain gauge device 100. In one embodiment, the rain gauge device 100 may include multiple brackets 124. In another embodiment, the stand 124 allows the rain gauge device 100 to be securely placed on the ground, such as a tripod.

The envelope 102 of the rain gauge device 100 is connected to the support 124 through the bottom surface 122 of the envelope 102 in a fixed but removable manner, for example, using screws and nuts. The support 124 preferably has a rigidity and an anchoring interface chosen such that vibrations of the envelope due to wind and/or external vibrations, for example, ground vibrations, are not transmitted to the elements positioned inside the envelope. The support 124 thus makes it possible to position the rain gauge device 100 in an agricultural field, in which the passage of agricultural machinery does not interfere with the operation of the rain gauge device 100.

The connection between the envelope 102 and the support 124 provides a secure and solid attachment of the envelope 102 to the device 100 and thus reduces the sensitivity of the envelope 102, as well as that of the elements positioned inside the envelope 102, to wind and external vibrations, as compared to a state of the art device where the envelope is not attached to the device support.

Thus, the rain gauge device according to the present disclosure can also be used in the agricultural field, because the disturbances due to external parameters on the measurements can be reduced. For example, the device according to the present disclosure allows to reduce the influence of vibrations due to the passage of agricultural machines in the field, which is not the case for a rain gauge device of the state of the art in the meteorological field.

The device 100 includes a water collector 104, positioned within the shell 102 centrally with respect to the Z axis, below the funnel shape 116 of the shell 102. The water collector 104 and funnel shape 116 are vertically aligned to allow water to be collected by the water collector 104 in an efficient manner, allowing all of the water entering through the opening 114 in the envelope 102 and passing through the funnel shape 116 to arrive in the water collector 104.

The water collector 104 includes a container 105. This container 105 has a weight p_{T}. The weight p_{T} corresponds to the weight of the water collector when empty, with no water inside to collect rainwater that enters through the opening 114 of the casing 102 and passes through the funnel shape 116. The container 105 includes a dropout 126 located on a lateral side 127 of the container 105. In FIG. 1A, the step 126 is positioned on the right side 127 of the container 105.

The water collector 104 also includes a counterweight 128. The counterweight 128 is positioned on an outer bottom surface 129 of the container 105. The counterweight 128 and the step 126 are positioned diametrically opposite each other on the container 105. In one embodiment, the counterweight 128 may also be in contact with a stopper. The counterweight 128 allows the water collector 104 to remain in the water collection position when the water collector 104 includes no water or includes less than the predetermined threshold amount of water for tipping. The counterweight allows the water collector to tilt into the drain position in a less abrupt and uncontrolled manner than in prior art devices that do not include a counterweight in which the water collector tilts against its own weight.

In one embodiment, the counterweight 128 rests on a stop in the water collection position. The step 126 and counterweight 128 are configured such that when the amount of water in the container 105 reaches a predetermined threshold, the center of gravity of the container 105 will be changed and will cause the container 105 to tilt (shown in FIG. 1B). Thus, the step 126 and the counterweight 128 make it possible not to use a magnet at the level of the water collector support to ensure the tilting of the container 105 from the collector 104, as in the prior art device. Moreover, the emptying of the container is done without electrical consumption, contrary to the device of the state of the art, when the latter uses electromagnets, for example.

The water collector 104 is movably connected to a first support member 130 of the device 100 to allow tilting. The first support member 130 does not include a magnet, as does the prior art device.

The counterweight 128 ensures that the container 105 returns to the collection position after tilting to the emptying position in a safe and accurate manner. Indeed, when the container 105 has emptied, the counterweight causes the container 105 to return to its collection position, which corresponds to a horizontal position, at 90° with respect to the first support member 130 and the central axis Z, and allows the container 105 not to remain in an intermediate position between the emptying position and the collection position, as may happen in a device of the state of the art having neither counterweight nor magnet, which would falsify the following measurements.

Moreover, the consequent weight of the container 105 due to the presence of the counterweight 128 limits the phenomena of rebound of the water collector 104, as it can happen in the device of the state of the art not comprising a counterweight and/or a magnet.

Likewise, the volume of the container 105 makes it possible to carry out the emptying less frequently compared to a device of the state of the art and thus makes it possible to limit the number of necessary emptying. Consequently, this also makes it possible to limit the phenomenon of bouncing that can accompany such emptying.

A connection 136 between the water collector 104 and the first support member 130 is provided at an end 130a of the first support member 130. The connection 136 between the water collector 104 and the end 130a of the first support member 130 is a pivot connection 136 and allows the water collector 104 to swing about an axis perpendicular to the Z-axis and the plane of FIGS. 1A and 1B. The pivot connection 136 thus allows the water collector 104 to move from a water collection position to a draining position, depending on the amount of water present.

The structural features of the water collector 104 allow the device 100 to not require the presence of a magnet located on the first support member 130 to hold the container 105 of the water collector 104 in the collection and measurement position as in the devices of the prior art. Thus, the structural features of the water collector 104 allow for a simpler design of the water collector 104 and thus the device 100 than in the prior art, without the presence of a magnet in the device 100.

In FIG. 1A, the water collector 104 is in the water collection position. In the water collection position, the water collector 104, and likewise the container 105, is positioned horizontally, parallel to the opening surface 114 of the enclosure 102 and at an angle of 90° to the first support member 130. Thus, in the water collection position, the water collector 104 can receive water that enters through the opening 114 of the enclosure 102. In the water collection position, the counterweight 128 allows the water collector 104 to remain in the water collection position until the water level in the water collector 104 exceeds the tipping limit.

At the time of tipping, the water collector 104 is oriented at an angle relative to the opening surface 114 of the shell 102 and the first support member 130 that is less than the angle of the drain position shown in FIG. 1B. Upon tilting, the water collector 104 includes the same amount of water as in the water collection position. Water only begins to drain from the water collector 104 when the water collector 104 has reached the drain position shown in FIG. 1B.

In FIG. 1B, the water collector 104 is positioned in the drain position, after tilting. In the draining position, the water collector 104 has tilted and is oriented at an angle to the opening surface 114 of the shell 102 and the first support member 130. In the drain position of FIG. 1B, the water collector 104 begins to drain by pouring out the water accumulated in the container 105 during the water collection position. The water is poured onto the side of the container 105 where the dropout 126 of the container 105 is located, through the dropout 126. The water collector 104 can empty completely or partially in the emptying position.

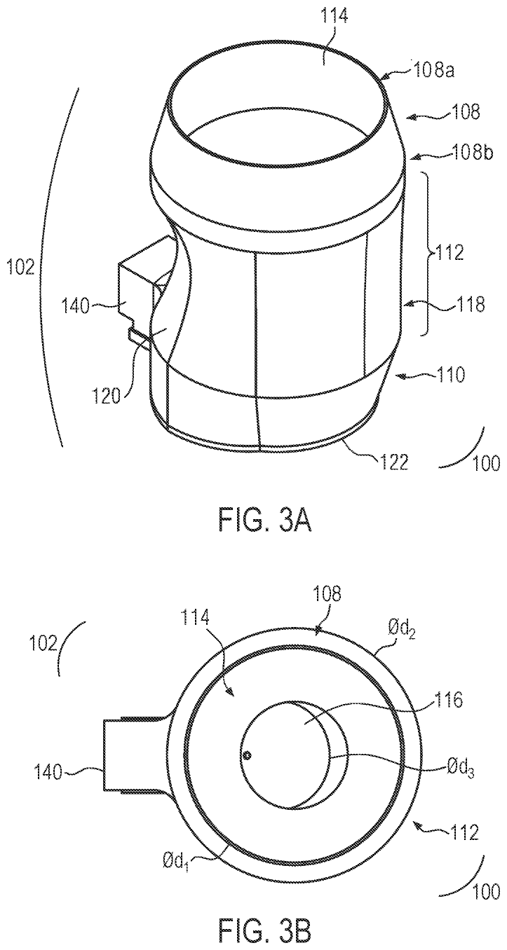

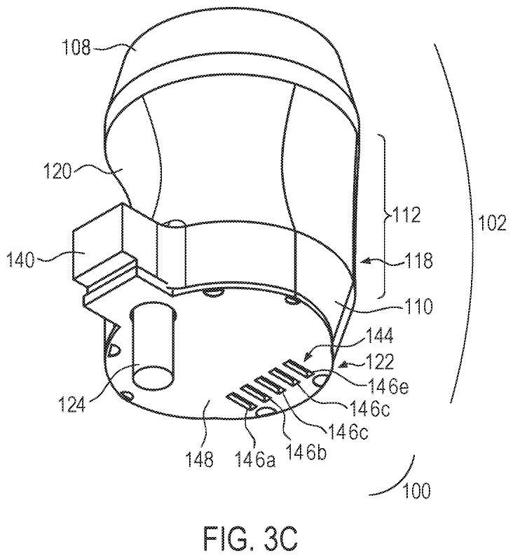

In one embodiment, an inclined plane is positioned below the water collector 104 on the inner surface of the bottom surface 122 of the envelope 102 to direct water draining from the collector 104 to a predetermined region of the bottom surface 122. Within the predetermined region of the bottom surface 122 are a plurality of ports 144 for venting water from the envelope 102, as illustrated in FIG. 3C.

In FIG. 1C, the water collector 104 is shown in its maximum drained position.

The first support member 130 is mounted to a second support member 132 of the device 100. As shown in FIG. 1A, the first support member 130 and the second support member 132 are attached at a 90° angle to each other. The connection 134 between the first support member 130 and the second support member 132 is made at an end 132a of the second support member 132 to an end 130b of the first support member 130. The second support member 132, like the first support member 130, also does not include a magnet. In one embodiment, no support member of the device 100 includes a magnet.

The second support member 132 of the device 100 is mounted at its other end 132b to a third support member 138. The third support member 138 may be a base, which itself is attached to the external support 124. Thus, the second support member 132 is connected to the support 124, via the third support member 138. Furthermore, through the first, second and third support members 130, 132, 138, the water collector is connected to the support 124 and is not directly connected to the casing 102 of the device 100. As already described, the support 124 with its rigidity and anchoring provides a mechanical separation between the casing 102 and the measuring means 106. Thus, the influence on the water collector 104 of external parameters, for example, wind vibrations or ground vibrations, which act on the envelope 102 of the device 100, is reduced compared to a device in which the envelope 102 is mechanically directly connected to the measuring means 106.

In FIG. 1A, the connection between the second support member 132 and the third support member 138 is a fixed connection, for example, made by screws and nuts. The connection between the second support member 132 and the third support member 138 allows for a reduction in the influence of external parameters, such as wind or ground vibrations, on the second support member 132.

Thus, the rain gauge device according to the present disclosure can also be used in the agricultural field, because the disturbances due to external parameters on the measurements can be reduced. For example, the device according to the present disclosure makes it possible to reduce the influence of vibrations due to the passage of agricultural machinery in the field, which is not the case for a rain gauge device of the state of the art in the meteorological field. This allows a wider and more varied choice of location for the device, without having to take into account external disturbances that could possibly disturb the measurements, as is the case for a rain gauge device of the state of the art.

A recess 140, located on the left side of the lower portion of the envelope 102, allows for easy passage of cables.

In one embodiment of the present disclosure, the rain gauge device 100 may comprise multiple water collectors, in particular, two. In this way, a constant measurement of rainfall can be performed, with the second water collector receiving rainfall while the first water collector is in its emptying position and vice versa.

The rain gauge device 100 further includes a measuring means 106 for measuring a parameter representative of a weight measurement. The measuring means 106 is positioned on the second support member 132, within the enclosure 102. Thus, the measuring means 106 is also mounted, like the second support member 132, on the third support member 138. The measuring means 106 is thus not directly mechanically coupled to the casing 102 of the device 100, such that it is mechanically isolated from the casing 102. In this way, a mechanical decoupling between the measuring means 106 and the casing 102 is achieved, which reduces the transmission of vibration from the casing 102 to the measuring means 106. This reduces the influence of external parameters such as vibrations due to the wind or ground vibrations on the measuring means 106 located on the second support member 132 and thus improves the quality of the measurements made by the measuring means 106.

The mechanical decoupling of the measuring means 106 from the casing 102 can be further improved by using a damper.

The measuring means 106 is thus connected to the support 124, via the first, second and third support members 130, 132 and 138. The support 124 being anchored in the ground in a fixed and solid manner, thus, the support 124 allows to act as a static reference for the measuring means 106 and allows to reduce the disturbances due to external vibrations on the measurements of the measuring means 106, compared to the devices of the state of the art.

Similarly, the measuring means 106, via the first and second support members 130, 132, is connected to the water collector 104.

The rain gauge device 100 according to the first embodiment operates as follows.

Rain enters the device 100 through the opening 114 in the device shell 102 and passes through the funnel shape 116 to be collected in the container 105 of the water collector 104. The water collector is in its water collection position. The measuring means 106 measures the weight of the water collector 104. When the water level has reached the predetermined threshold in the container 105, the container 105 flips to its draining position and the container 105 can drain. When the water has drained and the container 105 is empty, the counterweight 128 returns the container 105 to its water collection position. The device 100 resumes measuring the weight of the container 105, which corresponds to a tare. This tare of the container 105 corresponds to the weight p_{T} of the empty container 105. Using a communication means, preferably wireless, the measurement(s) are sent to the user via a server, storage means or cloud. Alternatively or additionally, the measurements are stored in a memory.

In one embodiment, the container 105 tilts to its drain position and partially empties. The container 105 may return to its water position although it is not completely empty. In this case, the device 100 resumes measuring the weight of the container 105 that corresponds to the tare. In this case, the tare corresponds to the weight p_{T} of the empty container 105 plus whatever water or trash remains in the container 105 after it is returned to its water collection position after tipping.

Thus, the device according to the present disclosure makes it possible to restart a measurement in the collection position after emptying automatically and immediately, because the stabilization period between emptying and the start of a new measurement is shorter than that of devices of the state of the art.

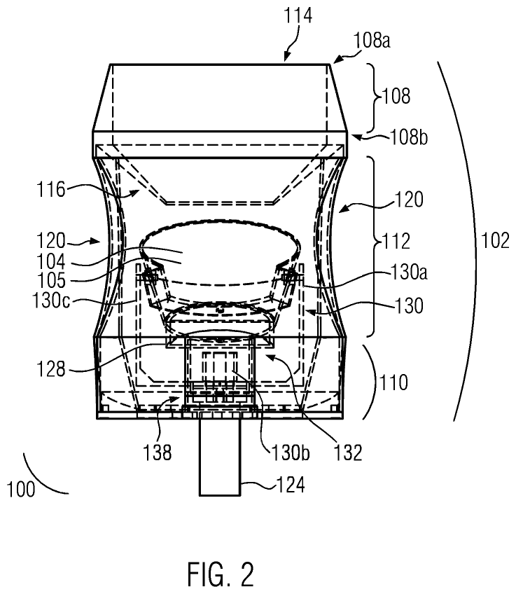

FIG. 2 shows a front view of the rain gauge device 100 according to the first embodiment of the present disclosure.

All features of the rain gauge device 100 shown in FIGS. 1A-1C will not be described again, but their description is referred to above with the same reference numbers used in FIGS. 1A-1C.

The front view of the rain gauge device 100 shown in FIG. 2 is in a plane parallel to the arrow Z shown in FIGS. 1A-1C.

As illustrated in FIG. 2, the first support member 130 is U-shaped, such that the pivot connection 136 between the water collector 104 and the first support member 130 occurs at both ends 130a and 130c of the sticks of the “U” of the first support member 130.

In the view shown in FIG. 2, the wall 118 of the central portion 112 of the envelope 102 is also at least partially curved on both sides at a portion 120 of the wall 118. The curved portion 120 of the wall 118 is curved horizontally toward the interior of the envelope 102 to improve the aerodynamics of the rain gauge device 100.

FIGS. 3A-3C represent a three-dimensional (3D) view of the rain gauge device 100 according to the first embodiment of the present disclosure. All features of the rain gauge device 100 shown in FIGS. 1A-1C and 2 will not be described again, but reference is made to their description above with the same reference numerals used in FIGS. 1A-1C and 2.

FIG. 3A shows the outer shell 102 of the rain gauge device 100 of FIGS. 1A-1C, according to the first embodiment of the present disclosure.

FIG. 3A shows the aerodynamic shape of the envelope 102 achieved by the wall 118 that is at least partially curved inwardly of the envelope 102, here represented by the curved portion 120.

FIG. 3B shows the top of the upper portion 108. Through the opening 114 of diameter di, the funnel shape 116 with the restricted opening of diameter d3 is seen.

FIG. 3C illustrates a 3D view from below of the rain gauge device 100 according to the first embodiment of the present disclosure.

FIG. 3C illustrates the lower portion 110 of the envelope 102 with the bottom surface 122. The bottom surface 122 includes a plurality of ports 144 for letting water escape while preventing wind from entering the interior of the envelope 102 at the bottom surface 122. Here, each port 146a-146e has an elongated shape, in particular, a rectangular shape. The apertures 146a-146e are aligned next to each other in a region 148 of the lower outer surface 122 of the flared portion 110. In one embodiment of the present disclosure, the apertures 146 a-146e may be arranged differently on the lower outer surface 122 of the flared portion 110 and separately so that they cover a larger area of the lower outer surface 122 of the flared portion 110.

The step 140 is connected to the lower flared portion 110 of the envelope 102.

The support element 124 of the device 100 is also visible in FIG. 3C.

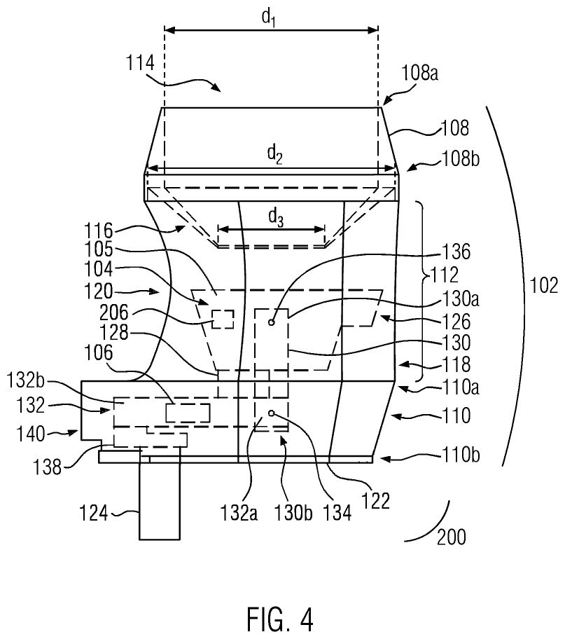

FIG. 4 represents a side view of a rain gauge device 200 according to a second embodiment of the present disclosure.

All features of the rain gauge device 200 of the second embodiment that are common with the rain gauge device 100 of the first embodiment shown in FIGS. 1A-1C will not be described again, but their description is referred to above with the same reference numbers used in FIGS. 1A-1C. In addition, the structure-based embodiments of the first embodiment can also be applied to the rain gauge device 200 of the second embodiment.

The rain gauge device 200 corresponds to the rain gauge device 100 of the first embodiment further comprising a second measuring means 206. This second measuring means 206 is a vibration measuring means, in particular, a piezoelectric sensor. In one embodiment, the second measuring means 206 may also be a hydrophone, a piezoresistance, a strain gauge.

The rain gauge device 200 has the same operation as the rain gauge device 100, but the second measuring means 206 allows the rain gauge device 200 to obtain more information than the rain gauge device 100.

In one embodiment, the rain gauge device 200 may not include a casing 102 according to the first embodiment but a casing as known in the state of the art.

The second measuring means 206 is positioned externally on a side wall of the container 105. In one embodiment, the second measuring means 206 may be positioned at another location on the container 105, for example, under the container 105. It may also be positioned inside the water collector 104. The second measuring means 206 may be bonded to a wall of the water collector 104 to provide a reliable and durable connection.

The second measuring means 206 measures the vibrations that are due to the raindrops falling into the water collector 104.

The second measuring means 206 thus allows the rain gauge device 200 to obtain additional information about the rainfall compared to the rain gauge according to the state of the art that measures only the volume or weight. The measurement obtained by the second measuring means 206 allows to obtain temporal information in the sense that the rain gauge device can now know when the rain started to fall, thus the beginning of the rainy episode. In addition, since the measurement of the second measuring means 206 is proportional to the impact of the rain, the measurement provides information about the type of rain that falls, for example, whether the rain includes large drops of water or whether it is a fine rain. Thus, the rain gauge device 200 provides temporal information about the rain and information about the type of rain that falls. This information allows to obtain an additional precision on the rainfall measurement and allows to obtain a more precise measurement and containing more information compared to the measurements of a rain gauge device of the state of the art.

Moreover, the second measuring means 206 being positioned on the water collector 104, thus inside the envelope 102, it allows to obtain a measurement that is protected from parameters external to the device, for example, wind vibrations or flying detritus. Thus, the rain gauge device 200 allows to obtain an improvement of the quality of the measurement compared to the rain gauge device 100 and compared to the rain gauge device of the state of the art.

In one embodiment, the device may include a third measuring means 306 positioned on the envelope 102 or on the support 124. In one embodiment, the third measuring means 306 may also be a vibration measuring means, in particular, an accelerometer or a piezoelectric sensor. In one embodiment, the third measuring means 306 may also be a hydrophone, a piezoresistance, a strain gauge.

The third vibration measurement means 306 located outside allows to obtain information on external disturbances, such as vibrations due to the wind or vibrations of the ground and thus allow to take them into account for a better evaluation of the rainfall measurements made by the device. This third vibration measurement means 306 thus also allows to obtain more information on the type of precipitation and not only the amount of precipitation obtained as in the devices of the state of the art. For example, by combining the third measuring means 306 with the second measuring means 206, it is possible to distinguish rain from other disturbances. It is therefore possible to do more advanced signal processing to analyze more finely the rain, for example, the type, the size, or the duration of the rain as well as the influence of the wind on the type, the size of the rain.

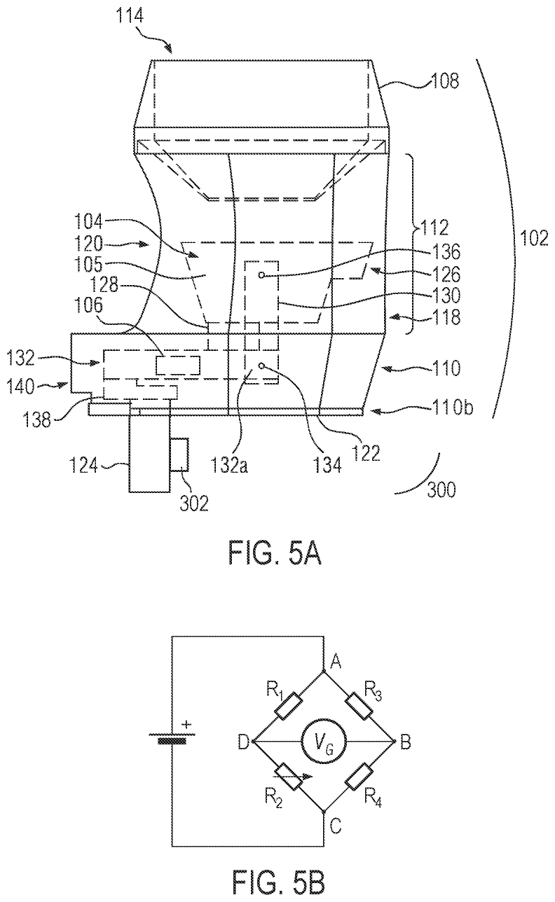

FIG. 5A represents a side view of the rain gauge device according to a third embodiment of the present disclosure.

The rain gauge device 300 is based on the rain gauge device 100 of the first embodiment. All features of the rain gauge device 300 of the third embodiment that are common with the rain gauge device 100 of the first embodiment shown in FIGS. 1A-1C will therefore not be described again, but their description is referred to above with the same reference numbers used in FIGS. 1A-1C. In addition, the variants based on the structure of the first and/or second embodiment may also be applied to the rain gauge device 300 of the third embodiment. In one embodiment, the rain gauge device 300 may not include a casing 102 according to the first embodiment but may include a casing according to the state of the art.

In FIG. 5A, the rain gauge device 300 is shown with the water collector 104 in its water collection position.

The rain gauge device 300 includes a control unit 302 configured to perform a plurality of weight measurements of the water collector 104, in particular, at regular intervals and to perform a plurality of weight measurements at different times. According to the present disclosure, a change in weight of the water collector 104 can thus be measured while the water collector 104 is filling with rainwater.

Furthermore, the plurality of measurements allows for a representative sample of the weight taking into account several external factors (vibrations, winds) and an average value of the weight can be obtained from the plurality of measurements. The plurality of weight measurements is performed continuously at a given time, in particular, the plurality of measurements comprises between 5 and 10 weight measurements at a given time.

After a fixed regular interval, chosen to minimize the power consumption of the device, at another given time, another plurality of measurements are made by the measuring means 106 of the device 300.

Thus, the device 300 of the present disclosure makes it possible to measure a variation in weight throughout the rainfall measurement. The device performs a plurality of weight measurements at several given instants unlike the device of the state of the art that only measures the weight at the time of tipping or determines the weight as a function of the number of tipping, or that determines the weight continuously.

In FIG. 5A, the control unit 302 uses a measuring means 106 in the form of a force sensor 106 to perform the measurements. This force sensor 106 corresponds to the second support member 132, which is a metal beam with a silicone part to protect it from water. The control unit 302 comprises, among other things, an analog/digital converter for processing the signals coming from the measuring means 106 and a microprocessor for the analysis and determination of the weight.

The force sensor 106 is connected at its one end 132a to the water collector 104, via the first support member 130, and at its other end 132b to the third support member 138. Thus, the force sensor 106 is also connected to the support 124 via the third support member 138. It is the support 124 that allows to act as a static reference for the measuring means 106 and allows to reduce the disturbances due to external vibrations on the measurements of the measuring means 106, compared to the device of the state of the art.

The second support member 132 flexes under the weight of the container 105, which is converted to a measure of weight.

To perform a weight measurement, the measuring means 106 includes a Wheatstone bridge. The Wheatstone bridge is located in the water-protected silicone portion of the beam as shown in FIG. 5A. In a known manner, a Wheatstone bridge is a set of four resistors R1, R2, R3, R4 electrically connected together, as shown in FIG. 5B, three of which are known and fixed and one unknown variable resistor. The Wheatstone bridge allows the change in the unknown resistance to be measured and associated with a measured parameter.

In this embodiment, the Wheatstone bridge is used to measure the change in the unknown resistance and associate it with the parameter of the weight of the water collector 104. The force sensor 106 is thus placed in the branch shown as CD in FIG. 5B, the other three resistors are fixed. As the second support member 132 flexes under the weight of the water collector 104, the unknown resistance R2 varies linearly with the weight allowing a measurement of the weight of the water collector 104.

Furthermore, in this embodiment, the Wheatstone bridge is also used in a different way to take into account the effect of temperature on the weight measurement. In addition to the variation of the unknown resistance, the control circuit is configured to also measure the other three resistances continuously. According to the diagram shown in FIG. 5B, there are four measurement points named A, B, C and D. According to this embodiment, all these measurement points are operated to measure R2 the beam resistance. All the resistances evolve in the same way with the temperature variation. Thus, by taking into account these four measurement points, thus by continuously measuring the four resistances, instead of relying on their value communicated at a temperature of 25° C., the temperature variation is automatically electrically compensated. The device 300 thus measures a plurality of electrical resistances at several given instants.

According to this embodiment, the device 300 allows the weight value to be measured while canceling the impact of temperature on the measurement. Thus, the device according to the present disclosure makes it possible to reduce the sensitivity of rainfall measurements with temperature variations.

In an alternative embodiment, the effects of temperature can also be taken into account by making abacuses (i.e., reference measurements) by measuring only the resistance R2 as a function of temperature and the device further comprises a temperature sensor.

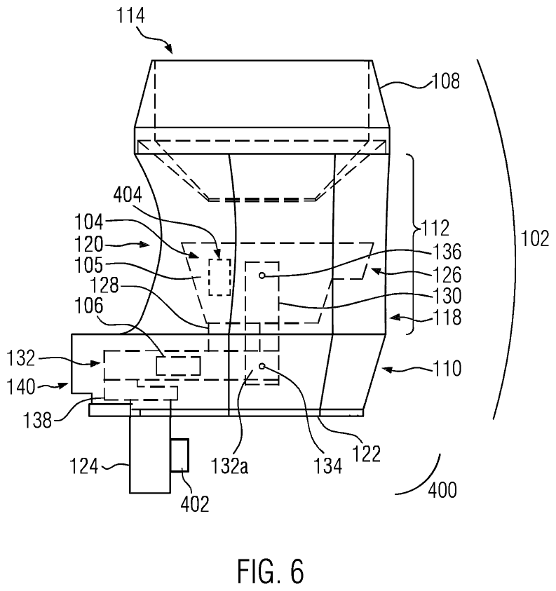

FIG. 6 shows a side view of the rain gauge device according to a fourth embodiment of the present disclosure. The device 400 is shown with the water collector 104 in the water collection or receiving position, but it may as well have the water collector 104 in the draining position. In one embodiment, the rain gauge device 400 may not include a casing 102.

The rain gauge device 400 corresponds to the rain gauge device 100 of the first embodiment and further comprises a control unit 402.

All features of the rain gauge device 400 of the fourth embodiment that are common with the rain gauge device 100 of the first embodiment shown in FIGS. 1A-1C will not be described again, but their description is referred to above with the same reference numerals used in FIGS. 1A-1C. In addition, variants based on the structure of the first, second or third embodiment can also be applied to the sensing device of the fourth embodiment.

The control unit 402 is configured to initiate a measurement of the measuring means 106 upon tilting of the water collector 104.

The rain gauge device 400 includes a tilt detection means 404, located at the water collector 104. The tilt detection means 404 may be a switch, in particular, a reed switch. A reed switch is a vacuum tube with two metal reeds inside. When a magnet, attached to the container 105, is brought close to the vacuum tube 404, the blades stick together allowing a current of electricity to flow. The absence of current therefore indicates a tilt. This tilt detection means 404 accurately detects the tilting of the container 105 from the water collector 104.

The tilting of the water collector 104 corresponds to when the water collector 104 begins to tilt, before the water collector 104 loses water. In fact, the tilting time before water loss is on the order of a second, the movement starts slowly until the water mass moves and the rotation of the water collector 104 toward the tilted emptying position accelerates and the actual emptying begins. Between the start of tipping and the start of emptying, a measurement of the weight of the container 105 is made, and thus allows a measurement of the weight of the container 105 at the time of tipping prior to the start of emptying the container 105 from the water collector 104. The tipping time before water loss is on the order of a second, and the time required for the control unit 402 to initiate a measurement of the measuring means 106 and for the measuring means 106 to measure a plurality of measurements is on the order of 100 ms.

Thus, the tilt detection means 404 allows to know exactly when tipping takes place and to measure the weight of the container at the time of tipping, prior to the start of emptying.

In one embodiment, the tilt detection means 404 may be located high and thus activated upon tilting of the water collector 104, thereby limiting power consumption in the water collection position. In this embodiment, the presence of power indicates a tilt.

The control unit 402 is also configured to reset the measuring means 106 after a tilt of the water collector 104.

The control unit 402 is positioned on the support member 124 in FIG. 6. However, in one embodiment, it may be positioned at another position on the device 400.

The control unit 402 resets the measuring means 106 after a tilt of the water collector 104 and especially after the emptying of the water collector 104 taking into account the tare of the water collector 104, i.e., the weight of the water collector 104 after emptying and upon returning to the water collection position. The water collector 104 is empty without water or partially empty after a tilt into its emptying position. After a tilt to its emptying position, the water collector 104 may indeed still have some water or detritus, which will change its weight for the next rain measurement. Thus, the weight measurement of the water collector 104 is reset to zero at the beginning of each new filling of the container 105, by measuring the tare of the water collector 104. Thus, measurement drifts due to soiling of the container 105 by leaves or dust are avoided. The measurements are therefore more precise and reliable.

The tilt detection means 404 accurately detects the tilting of the container 105 from the water collector 104 and also allows a measurement of the weight of the container 105 after the container 105 is emptied, when the container 105 is empty or partially empty to determine the tare.

The control unit 402 is configured to initiate a zeroing of the measuring means 106 after the water collector 104 has been switched to the drain position, when the water collector 104 has returned to its water collection/receiving position.

The device can thus be used continuously, as the resetting of the measuring means is carried out once the collector has returned to its horizontal collection position, after each tilting, which also allows an accurate measurement over an extended period of time. Furthermore, this avoids or at least minimizes the recalibration steps of the device and especially of the measuring means of the device, which are necessary during the life of the product and which are difficult to perform, unlike the device of the state of the art.

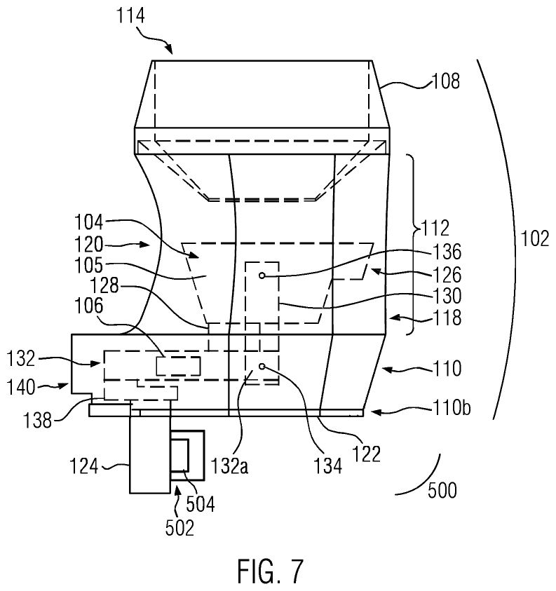

FIG. 7 shows a side view of the rain gauge device according to a fifth embodiment of the present disclosure. The device 500 is shown with the water collector 104 in the water receiving position, but it may as well have the water collector 104 in the draining position. In one embodiment, the rain gauge device 500 may not include a casing 102.

The rain gauge device 500 is based on the third embodiment of the present disclosure.

All features of the rain gauge device 500 of the fifth embodiment that are common with the rain gauge device 300 of the third embodiment shown in FIGS. 5A and 5B will not be described again, but their description is referred to above with the same reference numbers used in FIGS. 5A and 5B. In addition, the structure-based embodiments of the fourth embodiment can also be applied to the sensing device of the fifth embodiment.

The microprocessor of the control unit 502 is configured to put itself and/or the power-consuming component(s), such as a display, into sleep mode to reduce power consumption.

To wake up the microprocessor, the control unit 502 also includes a trigger means 504, which in this embodiment is integrated with the analog-to-digital converter.

The trigger means 504 is configured to measure the electrical voltage across the measuring means 106 and wakes up the microprocessor and/or any other component that has been placed on standby when a threshold is exceeded. Thus, it is sufficient to power the trigger means 504 and the force sensor 106. The rain and/or evaporation check is thus independent of the use of the control unit 502. Thus, in the device 500 according to the present disclosure, the rain check can be performed more often while having reduced power consumption. The device 500 can therefore perform a plurality of weight measurements at several given times while having reduced power consumption compared to a device of the state of the art that continuously measures weight.

Preferably, two thresholds are used, one with a low limit and one with a high limit. The crossing of the high limit upwards corresponds to the beginning of a precipitation that makes the weight in the water collector change. Thus, the microprocessor is awakened and configured to measure and record a plurality of weight measurements in a continuous manner. In addition, the time of the start of the rainfall can also be recorded. Once the rainfall is over, the microprocessor and/or any other power consuming component is put back into sleep mode and a new low and high threshold is determined and recorded.

After a regular time interval, chosen to optimize the energy consumption of the device, for example, every minute or every 5 minutes, the microprocessor is woken up again to make a plurality of weight measurements as before. If there was rain but below the threshold, the new value is saved and the low and high thresholds are updated.

If there is no rain, the time of the end of the rain can be recorded and the microprocessor and/or any other energy consuming component is put back in standby mode until the next wake up to have a follow-up on the evaporation and readjust the thresholds of the triggering means.

If the threshold is exceeded before the end of the standby period, the microprocessor is woken up to make a plurality of measurements as before, and the new value is recorded and the low and high thresholds are updated.

Exceeding the low limit corresponds to evaporation of water in the water collector 104 and thus to a loss of weight. If evaporation is not taken into account, the measurement of the amount of rainfall may be distorted. Indeed, it has been observed that strong evaporation of water, sometimes exceeding two millimeters in less than twelve hours, can take place over relatively short periods. Without taking into account this evaporation and if it rains again, the measured rainfall will only be that exceeding the last recorded rainfall, thus losing the two millimeters of difference linked to evaporation.

If again no weight change is determined, the control unit 502 is switched off and a new low and high threshold is determined and stored.

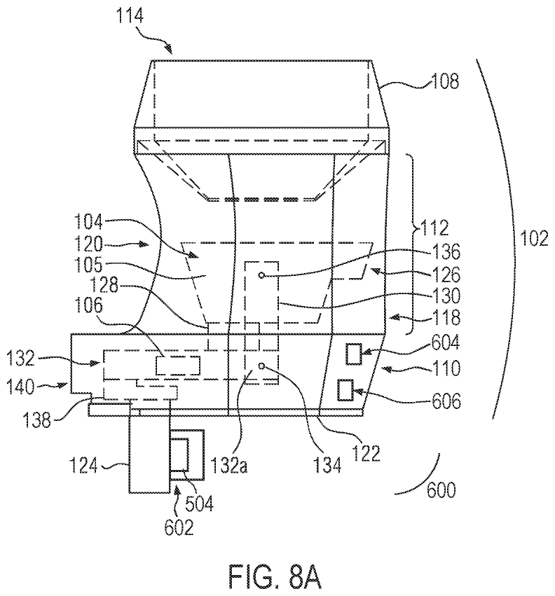

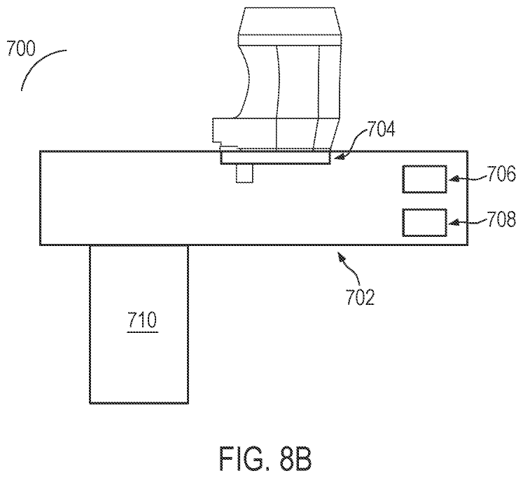

FIG. 8A shows a rain gauge device 600 according to a sixth embodiment. The rain gauge device 600 is based on the fifth embodiment and further includes a temperature sensor 604 and a humidity sensor 606 connected to the control unit 602. Alternatively, the rain gauge device 600 may be based on any of the other embodiments one through four.

The control unit 602 has the same functionality as the control unit 302, 402, 502 of the other embodiments and in addition is configured to receive temperature and humidity measurements from the sensors 604, 606.

These ambient parameters can have an influence on the rain measurement performed, especially on the presence or absence of dew. Thus, the amount of rain determined can be corrected when the presence of dew is detected. Indeed, with the coupling of the rain gauge device 600 with the humidity sensor 606 and the temperature sensor 604, the weather conditions leading to the formation of dew can be determined and thus, it is possible to take into account this “false” rain and to correct the rain measurement accordingly. According to a seventh embodiment, illustrated in FIG. 8B, a rain gauge device 100, 200, 300, 400, 500, 600, according to the first to sixth embodiments, is mounted on a connection interface 702 of a weather station using a suitable connection means 704. The interface 702 and the connection means 704 may be of the “plug and play” type, allowing at the same time a quick mechanical and electrical connection.

Thus, data can be exchanged between the rain gauge device and weather station sensors, such as a temperature sensor 706 and/or a humidity sensor 708. This data can then be processed by the rain gauge control unit and/or the weather station control unit and/or by a wirelessly connected remote control unit.

Due to its low electrical power consumption, the device may be an autonomous electrical power device. For example, the rain gauge device 100, 200, 300, 400, 500, 600 may include an autonomous energy supply device, in particular, solar, thermal or wind energy. The autonomous energy supply device allows for an essentially energy autonomous rain gauge device. This allows the installation of the rain gauge device at several locations in a field without the need for the installation of power lines.

A number of embodiments of the present disclosure have been described. Nevertheless, it will be understood that various modifications and improvements can be made without departing from the following claims.

1. A rain gauge device, comprising:
a water collector configured to receive water, the water collector being movable between a water collection position and a draining position;
measuring means configured to measure a parameter representative of a weight measurement; and
a control unit configured to use the measuring means to perform a plurality of weight measurements.

2. The rain gauge device of claim 1, wherein the measuring means is a force sensor.

3. The rain gauge device of claim 2, wherein the force sensor is a support element connected at one end to the water collector and at its other end to a support, the support element comprising a beam.

4. The rain gauge device of claim 3, wherein the force sensor is configured to be mechanically isolated from a casing by means of the support.

5. The rain gauge device of claim 1, wherein the measuring means comprises a Wheatstone bridge, the measuring means being configured to perform a plurality of electrical resistance measurements.

6. The rain gauge device of claim 1, wherein the control unit is configured to reset the measuring means after a tilting of the water collector.

7. The rain gauge device of claim 1, wherein the control unit is configured to reset the measuring means after a tilting of the water collector taking into account the tare of the water collector.

8. The rain gauge device of claim 1, further comprising a tilt detection means, the tilt detection means comprising a reed switch.

9. The rain gauge device of claim 1, wherein the control unit is configured to initiate a measurement of the measuring means upon tilting of the water collector and when the water collector has returned to its water collection position.

10. The rain gauge device of claim 1, configured such that the control unit is configured to be put in standby and further comprising a trigger means configured to wake up the control unit.

11. The rain gauge device of claim 10, wherein the trigger means is configured to wake up the control unit upon exceeding a threshold of the parameter representative of a weight measurement of the measuring means.

12. The rain gauge device of claim 10, wherein the triggering means is configured to wake up the control unit upon a downward overshoot of a low threshold or to wake up the control unit upon an upward overshoot of a high threshold.

13. The rain gauge device of claim 1, further comprising a temperature measuring means and/or a humidity measuring means, and wherein the control unit is configured to take into account the temperature and/or the humidity level when determining the weight.

14. The rain gauge device of claim 1, wherein the control unit is configured to detect the presence or absence of dew based on temperature and/or humidity.

15. The rain gauge device of claim 1, further comprising a casing, wherein the water collector and the measuring means are positioned within the casing, the casing comprising a central portion comprising a sidewall at least partially curved laterally inwardly of the casing, in combination with a flared upper portion and/or a flared lower portion.

16. The rain gauge device of claim 15, wherein the measuring means is mechanically decoupled from the casing.

17. The rain gauge device of claim 1, further comprising a second measuring means, the second measuring means being a vibration measuring means of the water collector being located at the water collector.

18. The rain gauge device of claim 17, further comprising a third measuring means, the third measuring means being a vibration measuring means located at a casing and/or at a support.

19. The rain gauge device of claim 18, wherein the vibration measuring means of the second and/or third measuring means is an accelerometer or a piezoelectric sensor.

20. The rain gauge device of claim 1, further comprising an autonomous energy supply device.
